(19) United States
(12) Patent Application Publication
(10) Pub. No.: US 2015/0211257 A1
(43) Pub. Date: Jul. 30, 2015

(54) FREE-WHEEL LOCK AND ASSEMBLY

(71) Applicant: VSI, LLC, Green Bay, WI (US)

(72) Inventors: Lucas Boesel, Muskego, WI (US); Daniel Bonness, Menomonee Falls, WI (US)

(21) Appl. No.: 14/607,235

(22) Filed: Jan. 28, 2015

Related U.S. Application Data
(60) Provisional application No. 61/932,411, filed on Jan. 28, 2014.

(51) Int. Cl. E05B 27/00; B60T 17/16

(52) U.S. Cl. CPC E05B 27/0003; B60T 17/16

(57) ABSTRACT

A free-wheel lock comprises a cylinder, a sleeve, a lock housing, a cam ring, a cam key, a spring, and a lock pawl, the lock pawl comprising lock pawl extension members. The free-wheel lock that is configured to allow a sleeve of the lock assembly to rotate along with a lock cylinder when the lock cylinder is rotated with an incorrect key or by other intrusive means. The free-wheel lock can be used with an air brake lock assembly whereby the lock pawl extension members are configured to engage the recesses of the locking plates to alternatively lock and unlock the air brake knobs of the air brake lock assembly.

This Application claims the benefit of U.S. Provisional Application No. 61/932,411, filed Jan. 28, 2014.

### FIELD OF THE INVENTION

This invention relates generally to locks, lock assemblies, lock systems and methods of operating locks. More particularly, this invention relates to a free-wheel lock that is configured to allow a sleeve of the lock assembly to rotate along with a lock cylinder when the lock cylinder is rotated with an incorrect key or by other intrusive means. Further, this invention particularly relates to an assembly that uses the free-wheel lock within the assembly.

### BACKGROUND OF THE INVENTION

In the art of locks, free-wheel lock assemblies are well known. Generally, such free-wheel locks used in such assemblies are constructed in a way that prevents the lock from being actuated when an improper key or other device is used in an attempt to rotate the lock cylinder of the lock.

Unless the proper key is inserted into the lock cylinder, the lock cylinder will “disconnect” from a driving mechanism of the free-wheel lock. Absent this functionality, use of an improper key could result in too much torque on the lock cylinder and its tumblers and a failure of the lock. Allowing the lock cylinder and its tumblers to “free-wheel” within the lock housing prevents overloading and breakage of the tumblers. To reset the free-wheel lock, the lock cylinder is rotated back to a “key-out” position where the lock cylinder is again coupled to the driving mechanism. Various components are necessary to achieve the free-wheeling functionality provided by such locks. In the view of these inventors, there is a need for an improved free-wheel lock and to an exemplary assembly with which such lock can be used.

### SUMMARY OF THE INVENTION

The free-wheel lock of the present invention comprises several elements. In the preferred, the free-wheel lock comprises a lock cylinder, a sleeve, a lock housing, a cam ring, a cam key, a spring and a lock pawl. When the lock cylinder is rotated with an incorrect key, the sleeve rotates along with the cylinder, since the tumblers will remain engaged. The sleeve and a cam ring both contain interlocking cam surfaces which interlock and allow engagement every 180° However, when the cylinder is turned 180°, the lock tail cannot engage with the cam key, which ensures that it will only engage every 360°. Further, the cam ring has four lugs that engage with the lock housing to prevent the cam ring from ever rotating. This prevents any rotational motion from ever being transmitted from the sleeve to the cam key. When the sleeve rotates the cam ring cams out. The cam ring pushes the cam key out. The cam key disengages with the lock tail, which allows the lock cylinder to spin without transmitting any rotation to the lock pawl.

In a preferred embodiment, the free-wheel lock is used with an air brake assembly of the type disclosed in the co-pending U.S. Provisional Patent Application No. 61/892,005 titled AIR BRAKE LOCK AND ASSEMBLY, which is incorporated herein by reference and in its entirety.

The foregoing and other features of the lock and assembly of the present invention will be apparent from the detailed description that follows.

### BRIEF DESCRIPTION OF THE DRAWINGS

FIG. 1 is an exploded perspective view of the free-wheel lock cylinder of the present invention.

FIG. 2 is a side elevational view of the free-wheel lock cylinder of the present invention showing how the lock cylinder would appear when an incorrect key is used with the lock cylinder.

FIG. 3 is another side elevational view of the free-wheel lock cylinder of the present invention but showing how the lock cylinder would appear when the correct key is used with the lock cylinder in accordance with the present invention.

FIG. 4 is a cross-sectioned side elevational view of the lock cylinder shown in FIG. 3 but showing how the lock cylinder tail remains engaged with the cam key when the correct key is used with the lock cylinder.

FIG. 5 is a cross-sectioned side elevational view of the lock cylinder shown in FIG. 2 but showing how the lock cylinder tail remains disengaged when the incorrect key is used with the lock cylinder.

FIG. 6 is a top perspective view of an air brake lock assembly that uses the free-wheel lock of the present invention.

FIG. 7 is a bottom plan view of the assembly shown in FIG. 6.

FIG. 8 is a bottom perspective view of the assembly illustrated in

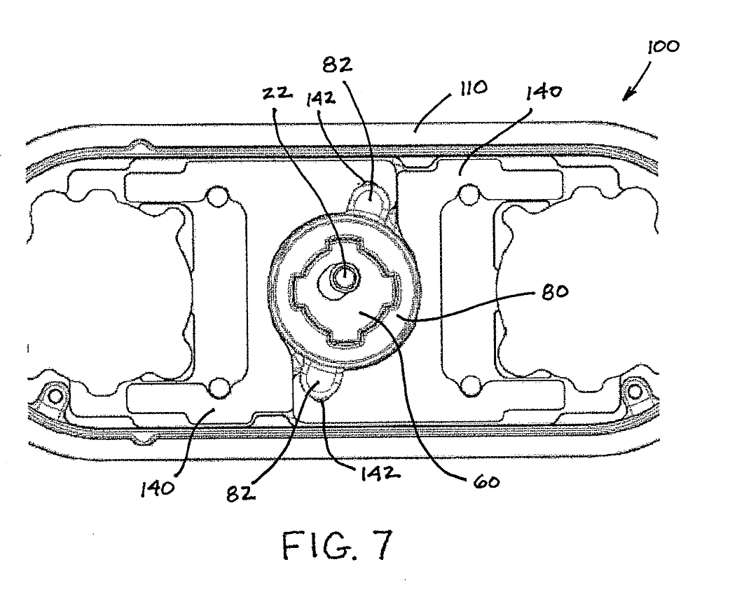

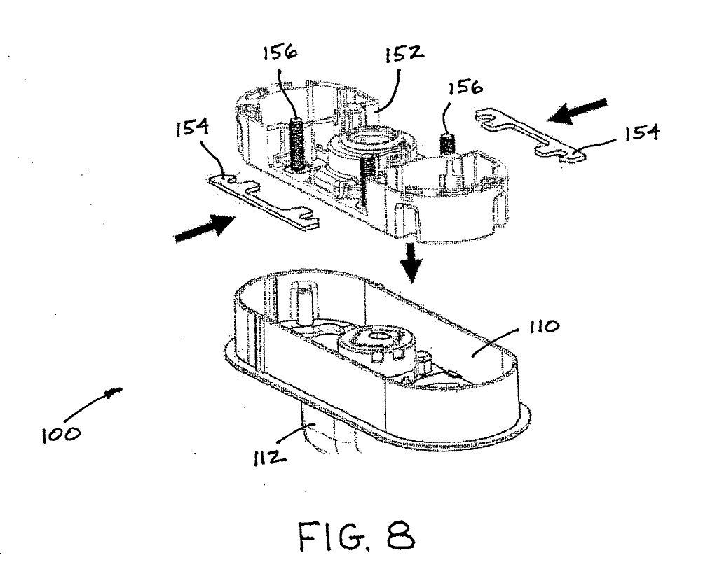

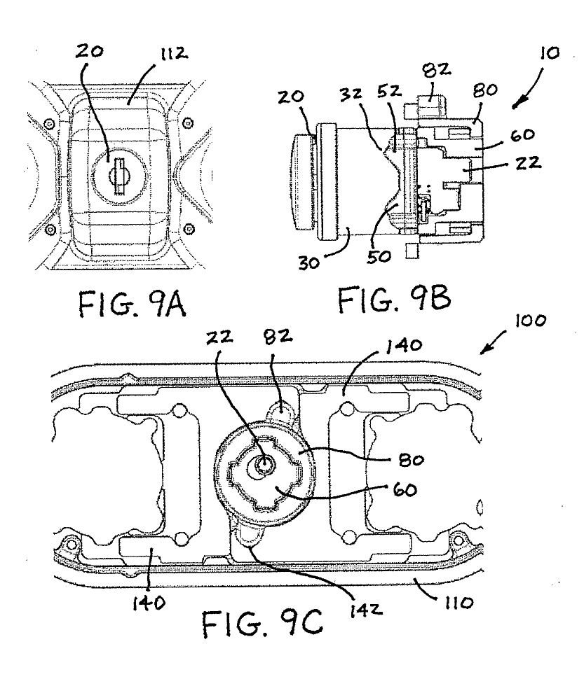

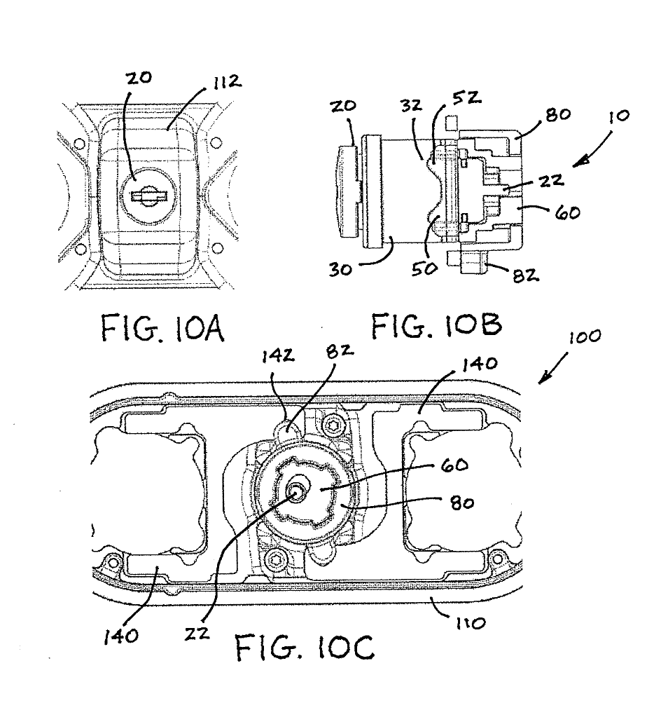

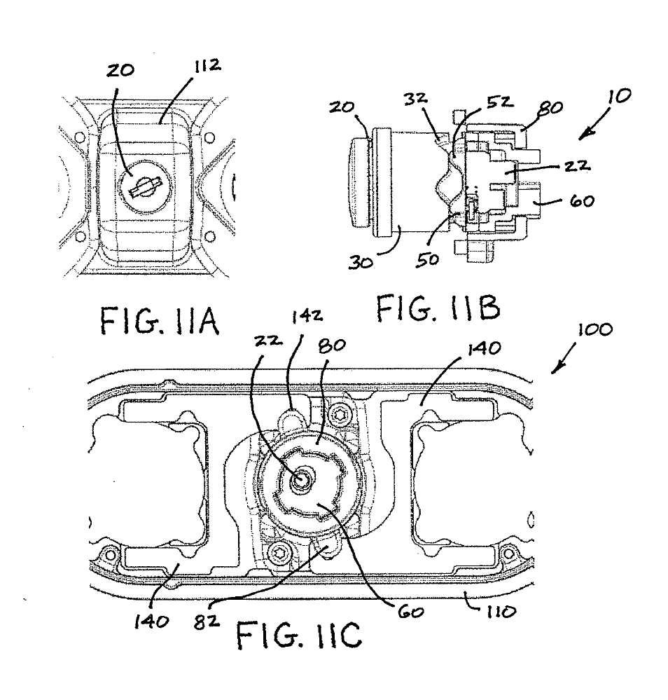

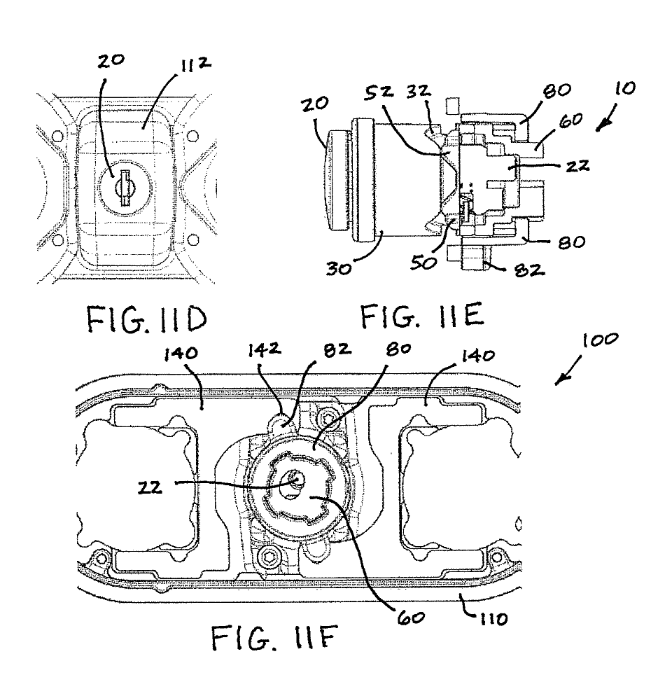

FIGS. 6 and 7 and showing the assembly partially exploded.

FIGS. 9A through 9C show several views of the free-wheel lock and assembly where the lock is in the “unlocked” position.

FIGS. 10A through 10C show several views of the free-wheel lock and assembly where the lock is in the “locked” position.

FIGS. 11A through 11F show multiple views of the free-wheel lock and assembly where an attempt is made to unlock the lock with an incorrect key.

FIGS. 12A through 12C show several view of the free-wheel lock and assembly where the correct key is used to reset the lock following an attempt to unlock the lock with an incorrect key.

### DETAILED DESCRIPTION

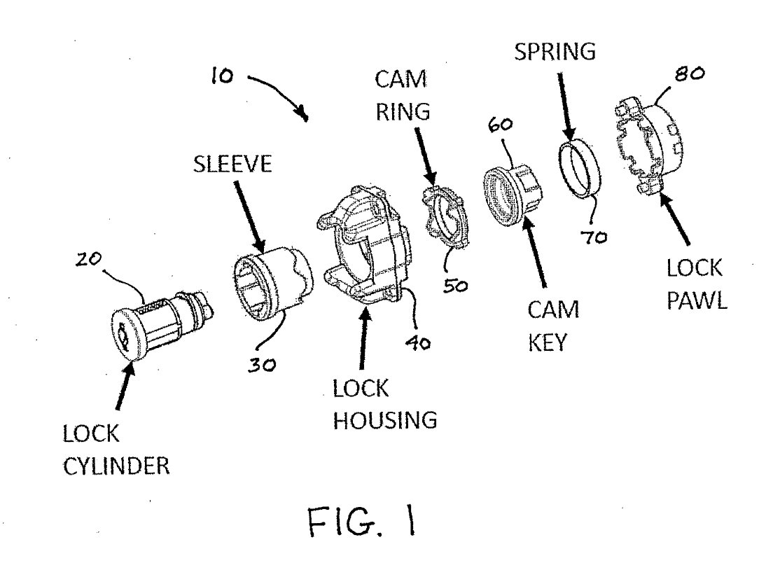

Referring now to the drawings in detail wherein like numbers represent like elements throughout, FIG. 1 illustrates an exploded perspective view of the preferred embodiment of the free-wheel lock, generally identified 10, that is constructed in accordance with the present invention. It is to be understood that the lock of the instant invention is not limited to use in any particular application and may be incorporated into any number of lock assemblies for doors, devices, containers, motor vehicles, and the like. The application, as will be presented below, is not a limitation of the present invention.

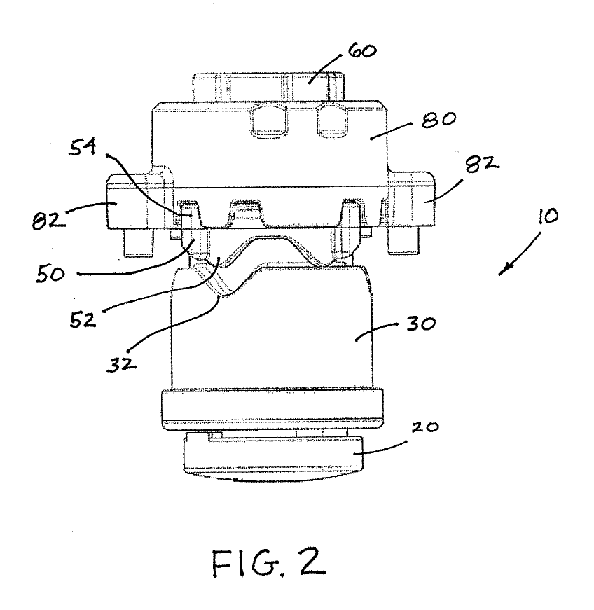

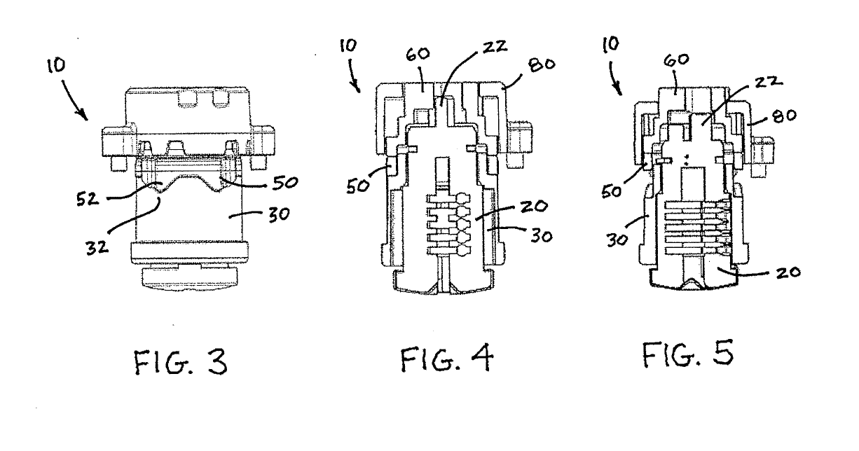

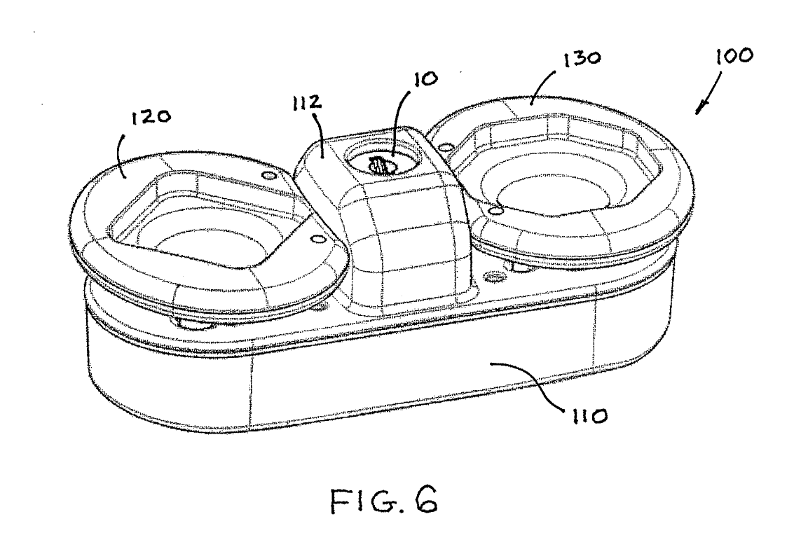

As shown, the free-wheel lock 10 includes a lock cylinder 20, a sleeve 30, a lock housing 40, a cam ring 50, a cam key 60, a spring 70 and a lock pawl 80. When assembled, the lock 10 appears as shown in FIGS. 2 and 3. Further, FIG. 5 shows a cross-sectioned view of the lock 10 illustrated in FIG. 2, whereas FIG. 4 shows a cross-sectioned view of the lock 10 as illustrated in FIG. 3. As shown in FIG. 4, when the correct key (not shown) is used with the lock 10, the tail 22 of the lock cylinder 20 remains engaged with the cam key 60.

On the other hand, when the lock cylinder 20 is rotated with an incorrect key (also not shown), the sleeve 30 rotates along with the cylinder 20, since the tumblers will remain engaged. The sleeve 30 and the cam ring 50 each contain interlocking cam surfaces 32, 52, respectively, which interlock and allow engagement every 180°. The slot in the cam key only allows engagement with the lock tail every 360°. The cam ring 50 also has four lugs 54 that engage with the lock housing 40 to prevent the cam ring 50 from ever rotating. See FIG. 2. This prevents any rotational motion from ever being transmitted from the sleeve 30 to the cam key 60. When the sleeve 30 rotates the cam ring 50 cams out. The cam ring 50 pushes the cam key 60 out. The cam key 60 disengages with the lock cylinder tail 22, which allows the lock cylinder 20 to spin without transmitting any rotation to the lock pawl 80.

Referring specifically to FIG. 5, it shows how the lock cylinder tail 22 disengages from the cam key 60, thereby allowing the lock cylinder 20 to rotate freely, without affecting the lock pawl 80. The cam key 60 and lock cylinder tail 22 only engage once every 360°, so the lock cylinder 20 rotates one revolution and then resets.

In a representative application, shown in FIG. 6, the free-wheel lock 10 is used with an air brake lock assembly, generally identified 100. The air brake lock system 100 comprises a housing 110 and a pair of knob enclosures 120, 130. A central portion 112 of the housing 110 is disposed between the knob enclosures 120, 130 and serves as the seat for the free-wheel lock 10 of the present invention. When viewed from below, as is shown in FIG. 7, it will be seen that the lock 10 is used with a pair of locking plates 140. The lock pawl 80 comprises opposing extension members 82 that engage recesses 142 defined within each of the locking plates 140. It is to be noted that the locking plates 140 are configured such that, by simple inversion, one plate 140 can serve the purpose of the other plate 140, which is a structural advantage for fabrication purposes.

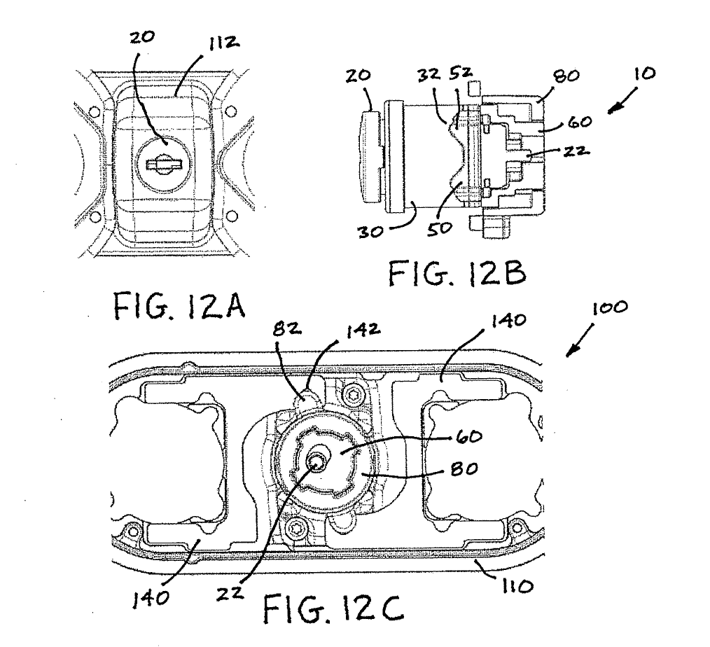

Referring now to FIG. 8, it shows the air brake lock assembly 100 as further comprising a lower block subassembly, generally identified 150, comprising a pair of opposing, but like-configured, lower plates 154. As shown, the lower plates 154 assemble from the sides of a spacer block 152 and are used to retain adjustment screws 156. This lower block subassembly 150 is installed into the housing 110 which effectively “traps” the lower plates 154 in place.

Referring again to FIG. 4 and now to FIGS. 9A, 9B and 9C, they show the assembly 100 and lock 10 in an initial “unlocked” position. That is, the sleeve 30 and the cam ring 50 are initially engaged, which allows the lock tail 22 to engage with the cam key 60. In the unlocked state, the lock pawl 80 holds the locking plates 140 in a retracted, unlocked position.

Using the correct key, the lock cylinder 20 is rotated 90° clockwise in order to place it in a “locked” position. Compare FIG. 9A with FIG. 10A. Using the correct key, the sleeve 30 doesn't rotate and the lock cylinder 20 remains engaged with the cam key 60. As long as the lock cylinder 20 remains engaged with the cam key 60, the rotational motion is transferred through the cam key 60 to the lock pawl 80. See also FIGS. 10B and 10C. Clearance in the slot on the cam key 60 only allows 33° of the 90° of the motion to transfer to the lock pawl 80, which is all that is necessary to position the plates 140 in the locking position.

Any attempt to unlock the lock 10 of the assembly 100 with a foreign object (such as an incorrect key), will result in the sleeve 30 rotating along with the lock cylinder 20 because the tumblers are still extended into the sleeve 30. This will cause the cam ring 50 and cam key 60 to cam outwardly and disengage the cam key 60 from the lock tail 22. The lock cylinder 20 and sleeve 30 need to rotate 25° before the lock disengages. The clearance in the slot on the cam key 60 allows time for the lock to disengage before any rotational motion is transferred through the lock tail 22 and cam key 60. See FIGS. 11A, 11B and 11C. Once the lock 10 becomes disengaged, the cylinder 20 and sleeve 30 can continue to be rotated without consequence. At this point, the lock tail 22 is not engaged with the cam key 60 or lock pawl 80. See FIGS. 11D, 11E and 11 F. In this situation, the locking plates 140 remain in the “locked” positions, as the lock cylinder 20 spins freely behind the cam key 60.

Referring now to FIGS. 12A, 12B and 12C, it will be seen that, by using the correct key (again, the key is not shown), the lock cylinder 20 can be rotated back to the locked position where it originally disengaged. At this position, the cam ring 50 will become re-engaged with the sleeve 30 and the lock tail 22 will re-engage with the cam key 60. Once re-engaged, the lock 10 of the assembly 100 will now function again as long as the correct key is used.

The details of the invention having been disclosed in accordance with the foregoing, we claim:

1. A free-wheel lock comprising:
a lock cylinder;
a sleeve;
a lock housing;
a cam ring;
a cam key;
a spring; and
a lock pawl.

2. The free-wheel lock of claim 1 wherein the sleeve comprises a cam surface and wherein the cam ring comprises a cam surface.

3. The free-wheel lock of claim 2 wherein the cam surfaces of the sleeve and the cam ring are interlocking.

4. The free-wheel lock of claim 3 wherein the cam surfaces of the sleeve and the cam ring allow engagement every 180°.

5. The free-wheel lock of claim 4 wherein the cam ring comprises four lugs that engage the lock housing to prevent rotation of the cam ring.

6. The free-wheel lock of claim 5 wherein the lock pawl comprises opposing extension members.

7. An air brake lock assembly comprising the free-wheel lock of claim 6, the assembly further comprising:
a housing, the housing comprising a central portion;
a pair of air brake knobs and air brake knob enclosures, one enclosure being disposed to each side of the central portion of the housing; and
a pair of locking plates, each locking plate comprising a recess;
wherein the lock pawl extension members engage the recesses of the locking plates to alternatively lock and unlock the air brake knobs.

8. The free-wheel lock of claim 1 wherein the cam ring and the lock housing are configured to prevent rotation of the cam ring and wherein any rotational motion is prevented from being transmitted from the sleeve to the cam key.

9. The free-wheel lock of claim 1 wherein the lock cylinder comprises a lock cylinder tail and wherein rotation of the sleeve rotates the cam ring and the cam key is pushed out thereby disengaging the lock cylinder tail and allowing the lock cylinder to spin without transmitting any rotation to the lock pawl.

10. The free-wheel lock of claim 9 wherein the cam key and the lock cylinder tail are engageable once every 360° thereby allowing the lock cylinder to rotate one revolution and then allowing it to reset.

11. The free-wheel lock of claim 1 further comprising a key and a lock cylinder tail wherein use of the key allows the lock cylinder to remain engaged with the cam key.

12. The free-wheel lock of claim 11 wherein use of an incorrect key results in rotation of the sleeve along with the lock cylinder, disengagement of the cam key with the lock cylinder tail, and spinning of the lock cylinder without the transmission of any rotation to the lock pawl.

13. The free-wheel lock of claim 12 wherein the sleeve and the cam ring comprise respective interlocking cam surfaces, the cam surfaces allowing engagement every 180°.

14. The free-wheel lock of claim 13 wherein the lock pawl comprises opposing extension members.

15. An air brake lock assembly comprising the free-wheel lock of claim 14, the assembly further comprising:
a housing, the housing comprising a central portion;
a central portion defined within the housing;
the free-wheel lock being disposed within the central portion of the housing;
a pair of air brake knobs and air brake knob enclosures, one enclosure being disposed to each side of the free-wheel lock; and
a pair of locking plates, each locking plate comprising a recess.

16. The air brake lock assembly of claim 15 wherein the lock pawl extension members engage the recesses of the locking plates to alternatively lock and unlock the air brake knobs.

17. An air brake lock assembly comprising:
a housing, the housing comprising a central portion;
a pair of air brake knobs and air brake knob enclosures, one enclosure being disposed to each side of the central portion of the housing;
a pair of locking plates, each locking plate comprising a recess; and
a free-wheel lock comprising a cylinder; a sleeve; a lock housing; a cam ring; a cam key; a spring; and a lock pawl, the lock pawl comprising lock pawl extension members to engage the recesses of the locking plates to alternatively lock and unlock the air brake knobs.

18. The air brake lock assembly and free-wheel lock of claim 17 wherein the cam ring comprises at least one lug and wherein the lock pawl comprises at least one slot such that the at least one lug slides into the at least one slot to prevent rotation of the cam ring.
